(19) United States
(12) Patent Application Publication
(10) Pub. No.: US 2010/0282344 A1
(43) Pub. Date: Nov. 11, 2010

(54) Self-Inflating Inflatable Display

(76) Inventor: Edward Francis Carolan, Mississauga (CA)

Correspondence Address: ADE & COMPANY INC., 2157 Henderson Highway, WINNIPEG, MB, R2G1P9, CA

(21) Appl. No.: 12/777,416

(22) Filed: May 11, 2010

Related U.S. Application Data
(60) Provisional application No. 61/176,972, filed on May 11, 2009.

(51) Int. Cl. G09F 19/00

(52) U.S. Cl. 137/565.17

(57) ABSTRACT

A self-inflating inflatable display features a body having an air impermeable flexible skin defining an interior enclosure of the body that is exandable and compactable by respective introduction and removal of air from the interior enclosure through at least one opening in the body. An air delivery device is fixed to the body and defines an openable and closable air flow passage communicating with the interior enclosure of the body and an external environment thereoutside through a respective opening in the body. The air delivery assembly includes an air conveying mechanism selectively operable to convey air from the exterior environment into the interior enclosure through the air flow passage to effect inflating of the body. There is no need to transport separate equipment for filling the inflatable, and the air conveying mechanism may be battery operated to allow operation at locations lacking easy access to mains power.

This application claims benefit under 35 U.S.C. 119(e) of U.S. Provisional Patent Application Ser. No. 61/176,972, filed May 11, 2009.

### FIELD OF THE INVENTION

The present invention relates generally to inflatable displays and more particularly to an inflatable display featuring built-in equipment operable to effect inflation of the display without need for a separate air pump or compressor and outside power source.

### BACKGROUND OF THE INVENTION

Use of inflatable displays as marketing, advertising, promotion and attraction tools has become quite commonplace.

A sealed air inflatable makes use of air impermeable material to form a flexible skin that encloses an interior space but leaves a closeable opening used to pumped or blow air or other gas into the interior space to fully inflate the display to its intended shape and is then closed off to seal the gas inside the inflatable so that this shape is retained by the pressure of the gas inside. When the display is no longer needed, for example at the end of an event at which the unit was used to form a display at a temporary location, the opening is re-opened to release the pressure differential between the inflatable's interior and the surrounding environment, and the inflatable can then be compacted or folded down into a reduced volume for transport or storage.

A cold air inflatable uses a skin of air permeable material and uses a continuously run fan to blow air into the interior space to replace air escaping outward therefrom to the surrounding environment to retain its shape instead of an initial filling and sealing off of the interior space like a sealed air inflatable. While this tends to better retain the shape of the inflated display compared to sealed air inflatables, where some air will escape over time after the initial filling through imperfections in the sealing of the unit's interior space, a cold air inflatable is not as energy efficient over time due to the need to continuously run the fan or blower.

Conventional sealed air inflatables rely on separate equipment to perform the inflation of the unit, such as a separately purchased air pump or compressor, which typically are not battery powered and accordingly rely on mains power for operation. Due to the need for constant air distribution, cold air inflatables use fans that are incorporated into the construction of, or at least provided with, the display, but also rely on mains power due to their relatively higher power consumption. Conventional sealed air inflatables thus require transport and set up of multiple items, and both types of inflatable displays are typically either limited to locations where mains power is readily available or require additional transport of sufficient power generating equipment.

In view of the forgoing shortcomings of the prior art, there is a desire for a more portable inflatable display that can be more easily transported and set up, or used at a wider range of locations.

### SUMMARY OF THE INVENTION

According to a first aspect of the invention there is provided a self-inflating inflatable display comprising:

a body having an air impermeable flexible skin defining an interior enclosure of the body that is exandable and compactable by respective introduction and removal of air from the interior enclosure through at least one opening in the body; and

an air delivery device fixed to the body and defining an openable and closable air flow passage communicating with the interior enclosure of the body and an external environment thereoutside through a respective opening in the body, the air delivery assembly comprising an air conveying mechanism selectively operable to convey air from the exterior environment into the interior enclosure through the air flow passage to effect inflating of the body.

Preferably the air conveying mechanism comprises a fan.

Preferably there is provided a power source fixed to the body and conductively connected to the air conveying mechanism to effect selective powering thereof.

Preferably the power source is disposed substantially within the interior enclosure.

Preferably the power source comprises a control device operable from the external environment to activate the air conveying mechanism.

Preferably the air delivery device and the power source are disposed at opposite sides of the interior enclosure.

Preferably the power source comprises a battery carrier fixed to the body and arranged to carry at least one battery.

Preferably the power source and the air delivery device are conductively connected through a flexible connection disposed at least partially within the interior enclosure.

Preferably there is provided a closure member operable from the outside environment to move between open and closed positions to open and seal off the air flow passage respectively.

Preferably the closure member is threaded to mate with a threaded end of the air flow passage.

Preferably the closure member is tethered to the air delivery device.

Preferably the air delivery device is disposed substantially within the interior enclosure.

### BRIEF DESCRIPTION OF THE DRAWINGS

In the accompanying drawings, which illustrate an exemplary embodiment of the present invention:

FIG. 1 is a schematic side elevational view of a self-inflating sealed air inflatable display according to the present invention.

FIG. 2 is a schematic side elevational view of the inflatable display of FIG. 1 from an opposite side thereof.

FIG. 3 is a schematic cross-sectional view of the inflatable display of FIGS. 1 and 2 as taken along line III-III thereof.

FIG. 4 is perspective view of fan and power supply assemblies of the inflatable display, each shown exploded along a respective vertical axis lying in a respective vertical plane.

FIG. 5 shows a cross-section of a closure plug of the fan assembly of FIG. 4 at the respective vertical plane thereof.

FIG. 6 is a perspective view of a closure plug tether of the fan assembly of FIG. 4.

FIG. 7 shows a cross-section of an outer inlet cap of the fan assembly of FIG. 4 at the respective vertical plane.

FIG. 8 shows a cross-section of an inner inlet cap of the fan assembly of FIG. 4 at the respective vertical plane thereof.

FIGS. 9A and 9B show a fan blade or impeller of the fan assembly of FIG. 4 in cross-section at the respective vertical plane and in plan view, respectively.

FIGS. 10A and 10B show a housing of the fan assembly of FIG. 4 in cross-section at the respective vertical plane and in perspective view, respectively.

FIG. 11 is a side elevational view of a motor of the fan assembly of FIG. 4.

FIGS. 12A and 12B show an outlet cap of the fan assembly of FIG. 4 in cross-section at the respective vertical plane and in perspective view, respectively.

FIGS. 13A and 13B show a battery box cover of the power source assembly of FIG. 4 in cross-section at the respective vertical plane and in perspective view, respectively.

FIG. 14 is a side elevational view of a switch of the power source assembly of FIG. 4.

FIG. 15 is a cross-section of an outer rim member of the power source assembly of FIG. 4 at the respective vertical plane.

FIG. 16 is a cross-section of a battery box of the power source assembly of FIG. 4 at the respective vertical plane.

FIG. 17 is a perspective view of a battery compartment divider of the power source assembly of FIG. 4.

### DETAILED DESCRIPTION

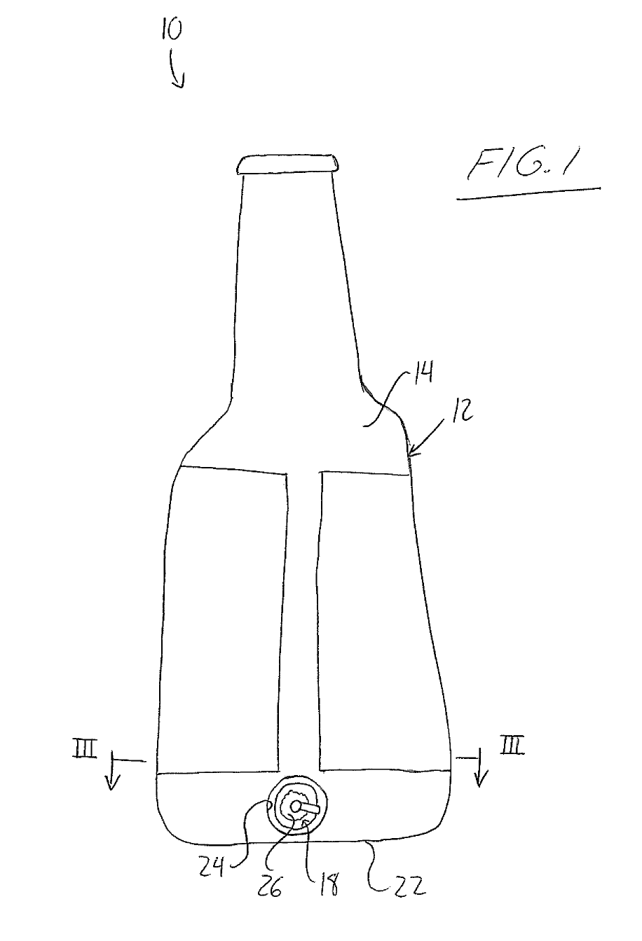

FIGS. 1 to 3 schematically illustrate a sealed air inflatable display 10 having a body 12 that, in a conventional manner, has a flexible skin 14 formed of air impermeable fabric or material to enclose an interior space 16 that can be expanded in volume through the forced introduction of air into this interior space inside the body so that the so inflated display will take on a predetermined three dimensional shape. The interior space is sealed off by closing any opening in the skin through which the air was delivered to trap the air inside and thus retain the predetermined inflated shape of the body for use as a promotional, advertising, marketing or attraction tool. When the display is no longer needed or desired at the site at which it was inflated, one or more openings in the skin are opened to allow the air from inside the body to escape, and the skin is collapsed down to minimize the interior volume.

The inflatable display differs from conventional sealed air displays however in that the body incorporates a fan assembly 18 and a power source assembly 20 fixed to the skin 14 for easy transport and storage of the inflatable body and equipment needed to inflate it together in a single integral assembly. At or just above the bottom 22 of the body 12 that sits atop the ground or other generally horizontal support structure on which the display is intended for placement, the fan assembly 18 has an outer end thereof disposed within an air flow opening 24 extending horizontally through the body 12 and sealed to the body 12 fully around this air flow opening 24 so that the rest of the fan assembly 18 projects horizontally into the interior space of the body 12 at or just above the bottom 22 of the display. The power source assembly 20 is mounted in the same manner in a power supply opening likewise situated just above the bottom 22 of the display at an opposite side of the interior space 16 thereof. In the illustrated embodiment, the flexible skin 14 of the body 12 is configured in a known matter to take on a shape reflective of a consumable liquid product bottle, thus giving the body 12 a circular horizontal cross-section when inflated so that the fan assembly 18 and power source assembly 20 are situated diametrically opposite one another over the circular bottom 22 of the display. It will be appreciated that this shape is presented in an exemplary context only, and a display in accordance with the present invention may take on any of a variety of three dimensional shapes when inflated. A lower portion of the display body including the bottom thereof may be given a rigid structure to provide continuous support for the assembled fan and power supply units, with the flexible skin of the display body sealed to the rigid bottom portion to lift away from the rigid bottom under inflation of the display.

Referring to FIGS. 1 and 2, sealed to the body 12 over the full perimeter boundaries of their respective openings therein, the fan assembly 18 and power source assembly 20 fully occupy these openings. The power source assembly thus fully closes off the power source opening in the body 12 in a substantially air-tight sealing manner. The fan assembly 18 is also fully sealed to the body 12 around its position seated at the air flow opening 24, but defines an air flow passage that communicates the interior space 16 of the body 12 with the outside environment externally surrounding the body 12. An openable and closable closure plug 26 is reversibly engagable at the outer end of the fan assembly 18 to selectively open the air flow passage to allow delivery of air into the body for inflation thereof or exit of air from the body for deflating thereof, and selectively close the air flow passage after inflation of the body to trap the air therein and retain the body in its inflated condition.

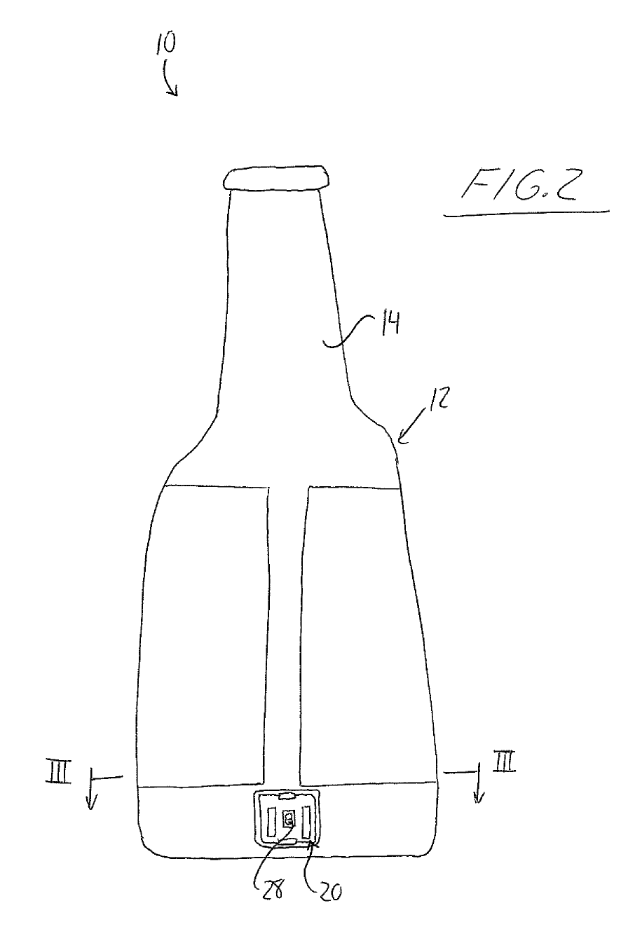

To inflate the body 12, the user flips a control switch 28 found on the outer end of the power source assembly 20 facing outward from the body 12 into an on position after having ensured that the closure plug 26 at the outer end of the fan assembly 18 has been disengaged to open the airflow passage. Referring to FIG. 3, a flexible cord 30 or bundle of wires disposed within the body's interior space conductively links batteries of the power supply assembly to a motor of the fan assembly 18 to activate the fan when the control switch 28 is turned to an on position. The motor drives a fan to draw air from the outside environment and force it onward through the air flow passage into the interior space 16 of the body 12 to effect inflation thereof. Once fully inflated, the user or operator may turn the switch to the off position to deactivate the motor driven fan and then reengage the closure plug 26 to close off the air flow passage, and thereby fully enclose the interior space of the body to keep the air forced thereinto trapped inside and thereby keep the body inflated.

If the body 12 is not fully sealed, for example due to minor imperfections in sealing between different elements of the display's construction, some leakage will occur. Resulting slow deflating of the display may be counteracted by periodically re-opening the closure plug and briefly running the fan to refill the interior space with air to the necessary pressure to expand the body to its fully inflated shape defining its intended display. The fan is deactivated and the plug is then re-closed again until such time as a further such top-up of air is required, or until such time as the display is no longer required.

When the display is no longer needed, the plug is disengaged to open the air flow passage to allow the air inside the body to escape to the surrounding environment. Other selectively openable valves, ports or openings may be provided in the body 12 to allow for faster deflating of the display by providing additional air flow passages between the body interior and the exterior environment. Of course when such additional air discharge passages are included in the body, effective inflating of the display requires that the operator ensure each such additional opening is closed during operation of the fan to fill the inflatable with air through the fan assembly's air flow passage. The display is collapsed by release of the air from therein, and this collapse may be hastened by manual encouragement by the operator forcing the display skin walls down toward the bottom of the display. With the display deflated, the inflatable body and the built-in inflating equipment defined by the fan and power source assemblies can be easily transported together to another location for storage or subsequent re-use at this new location.

FIG. 4 shows the fan assembly 18 and the power source assembly 20 in exploded states on the left and right sides of the figure respectively.

In order from its outer end outwardly facing the surrounding external environment to its inner end furthest within the inflatable body's interior space 16, the fan assembly 18 features the closure plug 26, an outer inlet cap 32, an inner inlet cap 34, a fan impeller 36 disposed within a housing 38, a motor 40 disposed within the housing 38 and an outlet cap 42 fitted over an outlet end of the housing 38 opposite the inlet caps 32, 34, these elements all being concentric with a central longitudinal axis 44 of the fan assembly.

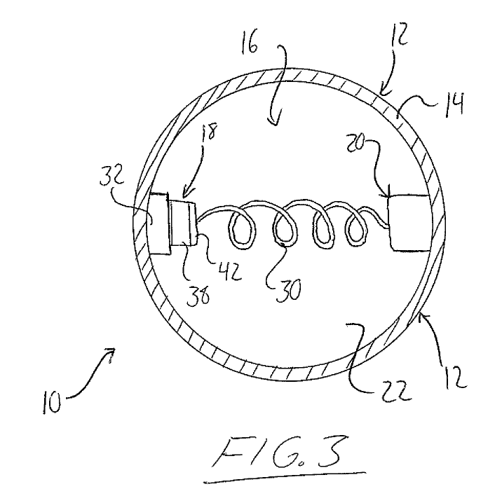

The closure plug 26, shown in isolation in FIG. 5 features a hollow externally threaded circular shaft portion 46 closed at an outer end thereof by a circular cap portion 48 that is concentric with and greater in diameter than the shaft portion 46 so as to project radially outward therefrom. A tether retainer 50 features a circular stem 52 projecting from the cap portion 48 in a direction opposite the threaded shaft portion 46 and an enlarged head 54 of greater diameter than the stem 52 fixed at an end of the stem 52 opposite the cap portion 48. A tether 56, shown in isolation in FIG. 6, features a flexible strip 58 having a smaller circular loop 60 carried at one end thereof and a larger circular loop 62 carried at an opposite end. The smaller loop 60 has an inner diameter that is greater the outer diameter of the tether retainer's stem 52 but less than the outer diameter of the tether retainer's head 54, so that the installed tether has its smaller loop encircled about the stem 52 and prevented from sliding thereof by the head 54. The larger loop 62 at the opposite end of the strip 58 is fixed to the inner inlet cap 34 when the fan assembly is installed, as described herein further below.

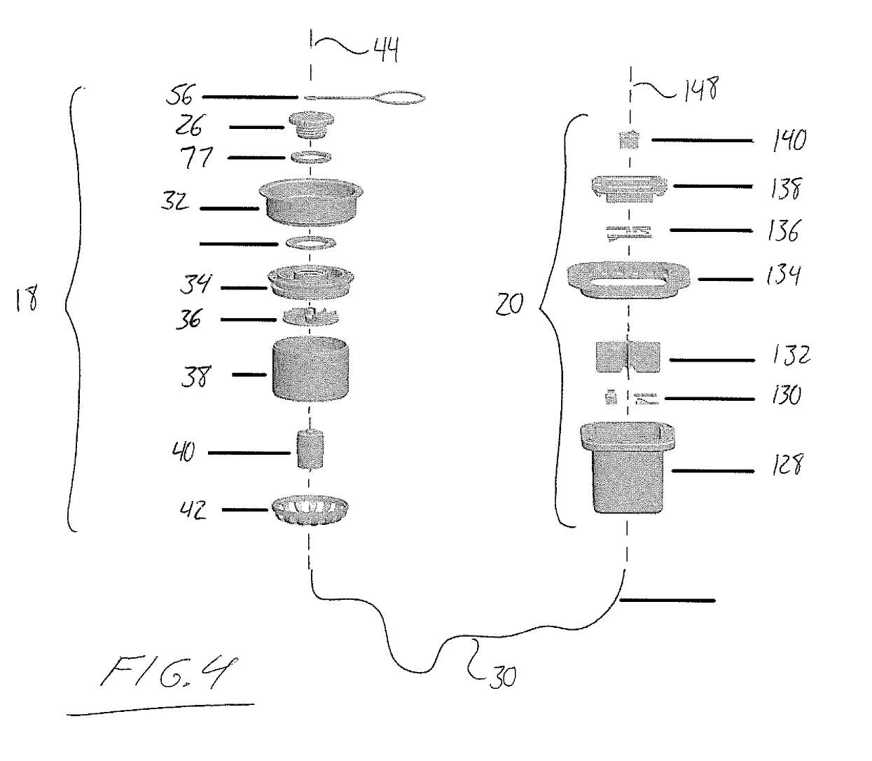

The outer inlet cap 32 shown in isolation in FIG. 7 is annular about the fan assembly's longitudinal axis 44 and features a mounting flange 64 projecting radially outward from the rest of the outer inlet cap 32 at an end thereof opposite the housing 38. This flange defines the greatest outer diameter of the fan assembly 18 at any point along the longitudinal axis 44 thereof and provides a flat annular ledge projecting outward from the rest of the fan assembly for sealing to the body 12 of the inflatable display 10, for example by heat welding.

The inner inlet cap 34 is received in the central opening of the annular outer inlet cap 32 so that a radially outward projecting flange 66 of the inner cap is received and locked into an internal annular groove 68 of the outer inlet cap 34. At an end of the outer inlet cap 32 opposite the flange 64 thereof when the inner inlet cap 34 is assembled thereto, the inner inlet cap 34 features an annular web 70 extending radially inward from an outer annular wall 72 from which the inner cap's flange 66 projects radially outward. An inner annular wall 74 projects toward the flanged end of the outer inlet cap 32, from the same side of the web 70 as the outer annular wall 72 projects to support the inner cap's flange 66, passing by the inner cap's flange 66 and the end of the inner cap nearest the flanged end of the outer inlet cap 32, but not past this flanged end of the outer inlet cap 32. The inner annular wall 74 is internally threaded to define a central threaded bore 76 of the inner inlet cap 34 concentric with the fan assembly's longitudinal axis 44. The threaded bore 76 is configured to matingly engage with the threaded hollow shaft 46 of the closure plug 26 to allow a user to selectively close off the threaded bore 76 to block air passage therethrough.

With reference to FIGS. 4 and 5, a gasket 77a may be seated in annular recess 77b provided in the side of the closure plug's circular cap portion 48 from which the threaded hollow shaft 46 projects to provide an improved air-tight seal between the cap portion 48 of the closure plug 26 and the end face of the inner annular wall 74 on which the bore threads are formed. Passage of air through the opening of the annular outer sleeve 32 at areas other than the threaded bore 76 is blocked by the inner inlet cap 34. The larger loop 62 of the tether 50 is sized to fit around the base of the inner annular wall 74 of the inner inlet cap to retain the tether and the attached closure plug 26 with the rest of the assembled fan installation. An annular washer or ring 79 has a circular opening sized to frictionally engage around the inner annular wall 74 over the larger loop 62 of the tether 50 to prevent the tether from sliding off the end of the annular wall 74 to prevent separation of the closure plug 26 from the rest of the fan assembly when installed.

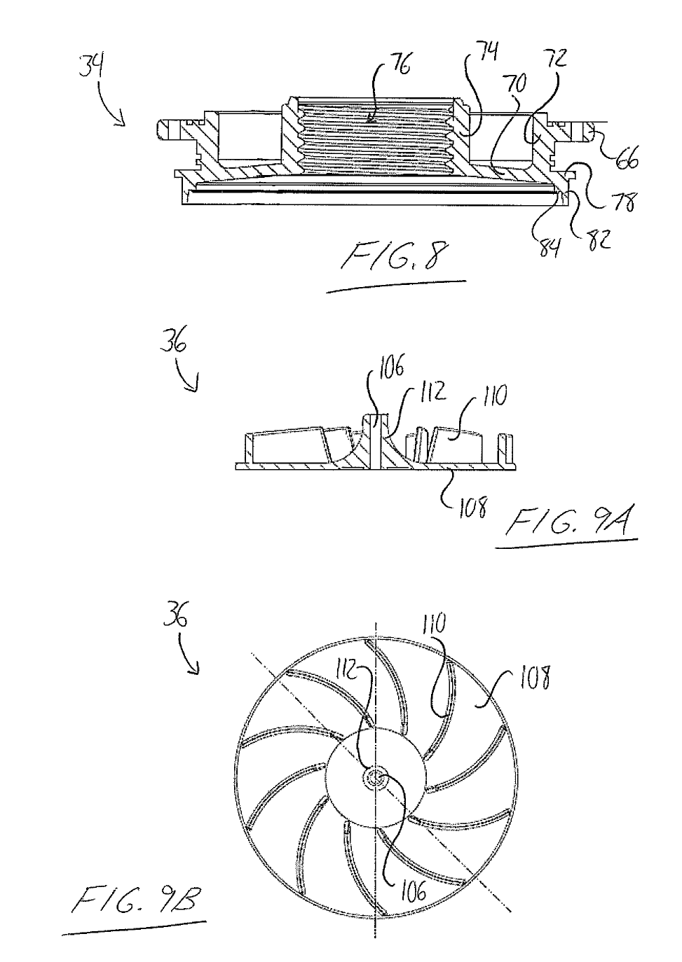

At a point along the fan assembly's longitudinal axis 44 approximately equal to the web 70 connected to the end of the threaded bore 76, the inner inlet cap 34 features an annular ledge 78 projecting radially outwardly away from the axis 44 parallel to, but not as far as, the inner cap's flange 66. An end 80 of the outer inlet cap 32 opposite the flange 64 thereof sits atop the ledge 78 when the inlet caps are assembled together. An annular rim 82 projects parallel to the longitudinal axis from a side of the ledge 78 opposite the inner cap flange 66. An inner surface of the rim 82 is stepped to form an inner shoulder 84 part way therealong so that a narrower distal portion of the rim 82 furthest from the ledge 78 will seat against a mating step 86 provided in a cylindrically annular outer wall 88 of the fan housing 38 shown in isolation in FIG. 10. An inlet side end face 90 of the fan housing cylindrical wall 88, formed by the thinner portion of the step 86 in the cylindrical wall 88, has the inner shoulder 84 of the inner inlet cap 34 seated atop it when the inner inlet cap 34 is installed on the fan housing 38. The fan housing and inner inlet cap are sealed and secured together at this mating of the pieces, for example by adhesive.

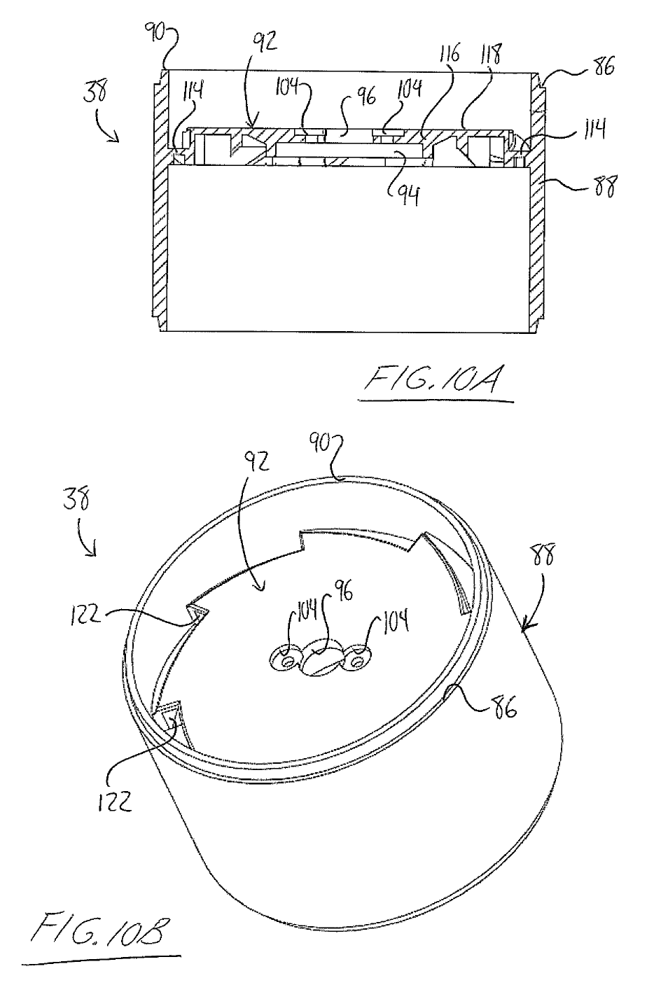

In the hollow interior of the cylindrical wall 88, the fan housing 38 features a mounting support 92 integrally connects to the cylindrical 88 over the full diameter thereof at a distance from the inlet end face 90 past the step 86, at which the end of the inner inlet cap 34 defined by the rim 82 thereof sits when the inner inlet cap 24 and the fan housing 38 are assembled. A circular central recess 94 of the mounting support 92 is recessed thereinto from a side thereof opposite the inlet end face 92 of the cylindrical wall 88 and is centered on the longitudinal fan assembly axis 44. A hole 96 of smaller diameter than the central recess 94 is also centered on the longitudinal axis 44 and communicates with the central recess 94 so that they cooperatively communicate the side of the mounting support nearest the inlet end face 90 with the opposite side of the mounting support 92. The central recess 94 is sized to receive an end face 98 of a housing 100 of the electric motor 40 shown in isolation in FIG. 11 so that the motor's driven shaft 102 projects centrally through the hole 96 along the longitudinal axis 44. A pair of counterbores 104 at diametrically opposite sides of the hole 96 extend into the mounting support 92 from the side thereof nearest the inlet end face 90 of the cylindrical wall 88 to communicate their narrow ends with the central recess 94 so that threaded fasteners can be passed through the counterbores to engage into the end face 98 of the motor housing 100 and secure the motor to the mounting support 92.

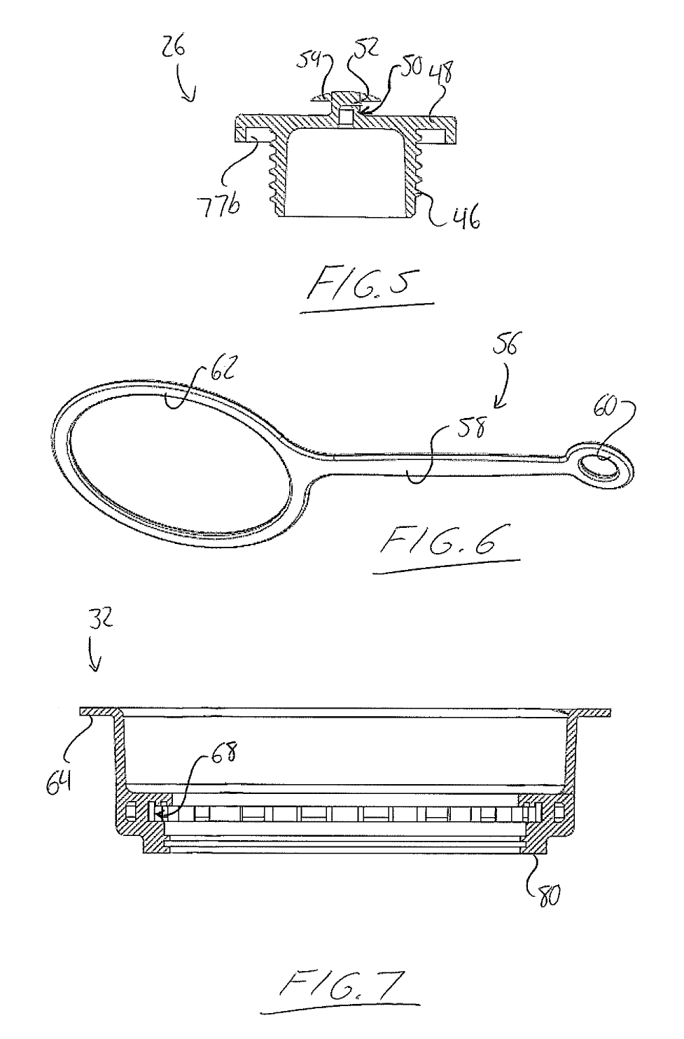

The fan impeller 36, shown in isolation in FIG. 9, features a central bore 106 therethrough sized for engagement into the driven shaft 102 of the motor 40 projecting through the mounting support 92 of the fan assembly housing 38 to support the fan impeller 36 for driven rotation about the longitudinal axis 44 between the mounting support 92 and the inlet end face 90 of the fan assembly housing 38. The fan impeller is of a conventional structure having a planar round disc-like base 108 with a plurality of vanes 110 projecting perpendicularly from the base at different radial positions about the central axis 44 passing through the central bore 106 defined by a bore collar 112 projecting from the base to the same side as the vanes.

Referring again to FIG. 10, the mounting support 92 has a plate like annular base portion 114, which is normal to the longitudinal axis and forms the connection to the cylindrical wall 88, and an elevated portion 116, which projects from the base portion toward the inlet end face 90 of the cylindrical wall. A face 118 of the elevated portion 116 opposite the planar base portion 114 is parallel to the plane of the base portion 114, and the hole 96 and counterbores 104 extend into the mounting support 92 from this face 118. Viewed in plan from the end face 90 of the housing 38, the mounting support face 118 has shape generally resembling that of a circular saw blade, that is, generally round but with the periphery divided into separate sections that are separated by radii equally spaced about the central axis 44 and each arcuately curve inward from a circular path defining the outermost extent of the periphery from one of the section dividing radii to a next in a common direction about the central axis. Peripheral walls of the elevated portion 116 projecting from the base portion 114 along the axis and curving thereabout define these arcuate sections of the face's periphery. With the motor installed into the central recess of the mounting support 92, an end portion 120 of the motor from which the driven shaft 102 extends and which is of smaller diameter than the motor housing end face 98 fills the central hole 96 in the mounting support 92. The portion's of the fan housing's interior on opposite sides of the mounting support 92 are therefore only communicated with one another through openings 122 (see FIG. 10B) each defined in the mounting support 92 in a respective one of the radial planes dividing the periphery of mounting support face 118 into the different arcuate sections. Each such opening is bound on its four sides by the two adjacent arcuate peripheral walls of the elevated portion 116 meeting at this radial jutting of the periphery, the planar base portion 114 of the mounting support 92 and the planar part of the mounting support's elevated portion 116 defining the face 118 thereof. These openings 122 provided the only fluid communication between the opposing sides of the mounting support 92.

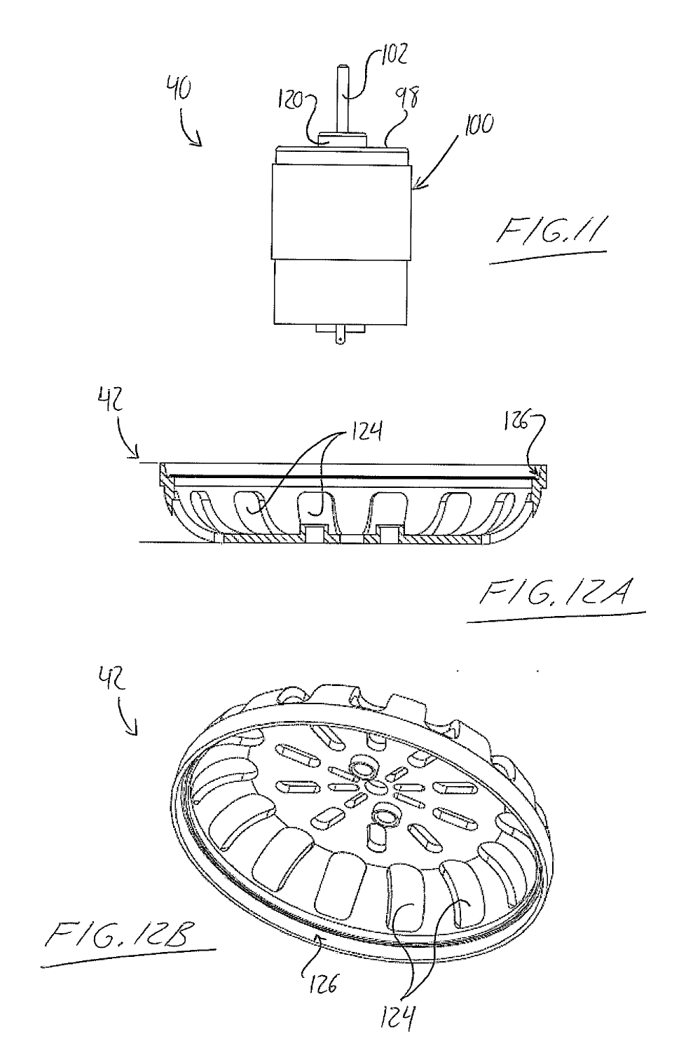

The end of the fan assembly housing 38 opposite that to which the inner inlet cap 34 is fitted features the outlet end cap 42, which is shown in isolation in FIG. 12. The outlet end cap 42 has a basket or cage like structure provided with a plurality of large air flow openings 124 formed therein. A completely open annular end 126 of the outlet end cap 42 is stepped to form a complimentary fit with another stepped end of the fan housing 88 opposite the inlet face 90 thereof so that the fan housing fits together with the outlet cap in the same manner as the inner inlet cap.

With the motor housing 100 contained within the fan assembly housing 38 between the mounting support 92 thereof and the outlet cap 42, operation of the motor drives rotation of the fan impeller 36 on the opposite side of the mounting support 92. With the closure plug 26 unscrewed from the threaded bore 76 of the inner inlet cap 34, this draws air from the exterior environment outside the inflatable display body 12 through the threaded bore 76 of the inner inlet cap and into the fan assembly housing 38 along the longitudinal axis 44 of the fan assembly, which coincides with an axial direction of the fan impeller 36. Here, where the air meets the centrifugal fan impeller, it is moved outward toward the inner surface of the fan assembly housing's cylindrical wall 88, the fan being rotated in the appropriate direction to encourage air flow into the openings 122 of the mounting support 92, thereby forcing the air to the side of thereof opposite the fan impeller for subsequent exit from the fan assembly housing 38 through the outlet cap 42 into the interior space of the inflatable display. In other words, with the outer inlet cap 32 sealed to the inflatable body around an opening in a wall thereof, the fan assembly's inlet caps, fan housing and outlet cap collectively define a sealed air flow passage that communicates the external environment with the interior space of the inflatable body only when the closure plug 26 is removed to open this passage, and through which air is delivered into the interior of the inflatable display body through operation of the fan.

Turning now to details of the power source assembly 20, it features an air tight battery box 128, a first set of battery contacts 130, a battery compartment divider 132, an outer rim member 134, a second set of battery contacts 136, a battery box cover 138 and a control switch 140.

With reference to FIG. 16, the battery box 128 features four side walls 142 and a single square end wall 144 cooperating to enclose five out of six sides of a three dimensional space and thereby define a battery compartment sizes to receive and store a plurality of individual batteries therein. The first set of battery contacts 130 are secured to the interior face of the end wall 144, which may involve cooperation of interior projections formed on the end wall with holes metal sheet battery contacts to positively position the first set of battery contacts in appropriate positions and orientations along the end wall 144 to engage with respective terminals of batteries placed against the contacts when inserted into the compartment through the open end thereof. Each of the side walls 142 features a pair of parallel ribs 146 projecting a short distance into the battery compartment and extending from the end wall 144 toward the opposite open end of the battery box 128 along a central longitudinal axis 148 of the power source assembly.

FIG. 17 shows the battery compartment divider 132 having four equally-sized planar fins 150 projecting outward from a central body 152 at ninety degree spacing between adjacent fins to give the divider a cruciform cross section in a plane normal to the power source longitudinal axis 148. The thickness of each fin is such that installation of the divider is achieved by sliding the divider into the interior compartment of the battery box 128 to slide each fin into the space defined between the ribs 146 of a respective side wall 142. The divider thus divides a portion of the battery compartments depth adjacent the end wall into four equally sized sections, each intended for receipt of an end of a respective battery. The fins sit atop the end wall 144 and a respective end of the central body 152 is recessed from the sitting ends of the fins to accommodate a central projection 154 extending into the battery compartment along the central longitudinal axis 148 from the end wall 144 a distance less than the length of the ribs 146. A pair of bores 156 pass through the projection in a direction parallel to the central axis 148 and communicate with a parallel central bore 158 extending through the central body 152 of the divider 132. These communicating bores accommodate passage of the wires 30 connecting the fan and power source assemblies into the battery compartment.

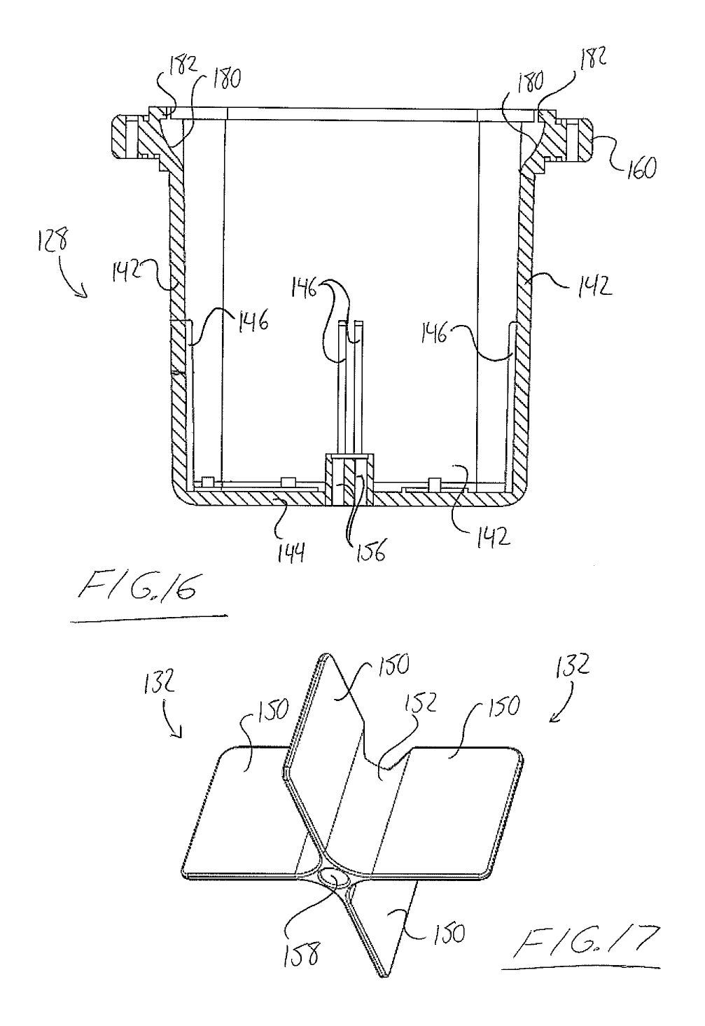

The battery box 28 features an outwardly directed flange 160 extending fully therearound adjacent the open end thereof to project outward from all the side walls 142 in a direction normal to the central axis 148. The rim member 134, shown in isolation in FIG. 15, is square and features an inner groove 162 extending into it around its square central opening for receipt of the battery box flange 160 when these two components are assembled. The rim member 134 features a thin outwardly directed flange 164 projecting outward from the rest of the rim member 134 fully therearound at an end of rim member 134 situated nearest the open end of the battery box 128 when installed thereon. Like the outer cap flange of the fan assembly, this flange 164 forms the radially outwardmost extent of the power supply assembly at any point along the respective longitudinal axis 148 to form a suitable area at which the power supply assembly can be sealed to a wall surface of the inflatable body, for example by heat welding. With reference to FIGS. 15 and 16, the rim member flange 164 of the illustrated embodiment sits generally flush with the open end of the battery box 128 when installed therein.

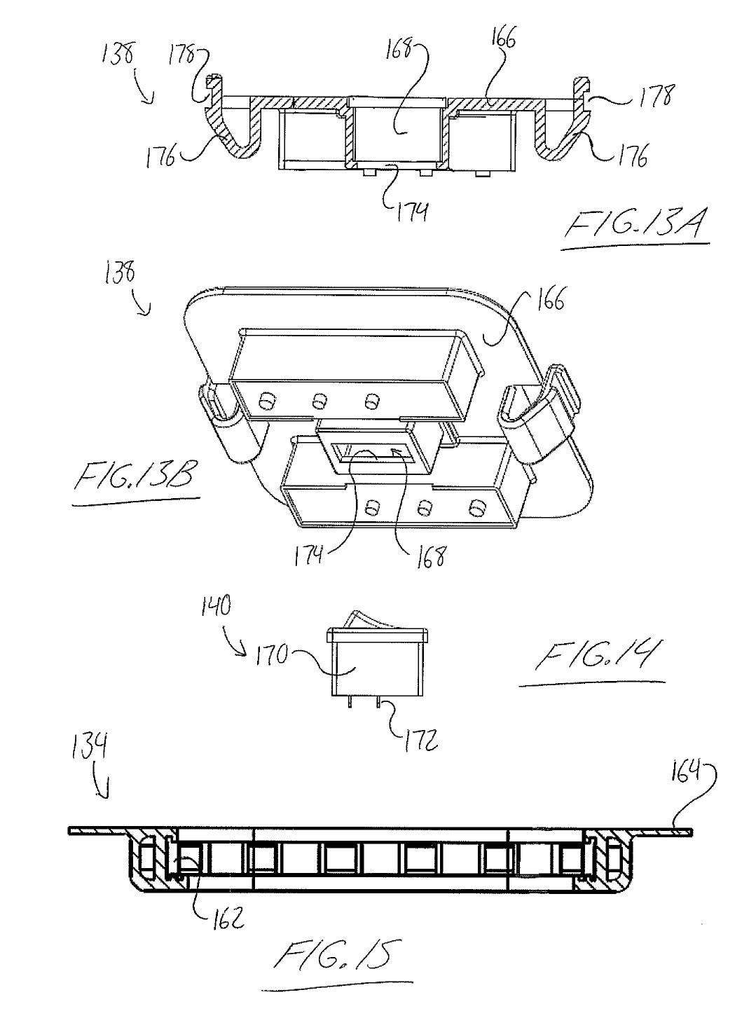

FIG. 13 shows the battery box cover 138 arranged to engage to the assembled battery box 128 and rim member 134 to close off the open end of the battery compartment. The battery box cover 138 features a planar cover portion 166 from which a rectangular switch compartment 168 depends at a central position on the cover. The on/off switch of FIG. 14 fits substantially within the switch compartment 168, with the switch housing 170 seated on the bottom of the switch compartment 168 and conductive electrical contacts 172 of the switch projecting into or through an opening 174 left in the bottom of the switch compartment to accommodate passage of wire conductors between the switch compartment and the battery compartment. Near, but inward from, two opposing sides of the generally square cover portion 166, two generally U-shaped resiliently flexible catch tabs 176 integral with the cover portion each depend perpendicularly therefrom to the same side thereof as the switch compartment 168, then curve away from the center of the cover portion and back toward the cover portion, then extend obliquely toward the respective peripheral edge thereof, and then finally extend perpendicularly past the cover portion 166 to the side thereof opposite the switch compartment at the respective peripheral side edge. A recess 178 in the portion of each tab 176 projecting linearly past the cover portion 166 is provided in a face of the tab facing away from the cover portion 166 at a position generally aligning therewith to catch on a mating feature on the battery box 128 to releasably secure the battery box cover 138 to the battery box.

Referring to FIG. 16, two opposing ones of the side walls 142 of the battery box 128 deviate from their otherwise planar structure at a position just to the side of the battery box flange 160 opposite the open end of the battery compartment. Here, at the widthwise center of these two side walls, the inner surface slopes outwardly at an angle or curve substantially following the shape of a respective one of the catch tabs 176 where it angles outward toward the respective side edge of the cover portion 166 of the battery box cover. The open end of the battery box 128 is defined at the outer end of these sloped portions 180 of the two battery box walls, and the battery box wall juts a short distance back toward, without reaching, the inner end of the sloped portion 180 in a direction parallel to the battery box bottom 144. Lowering the battery box cover 138 onto the battery box 128 to seat the planar cover portion 166 of the cover 138 generally flush with the open top of the battery box 128 brings the outwardly sloping portions of the catch tabs 176 into contact with the inward jutting ends 182 of the sloped wall portions 180 of the battery box, causing the tabs to flex inward to move past these jutting ends 182, at which point the tabs 176 are resiliently released back outward to their above-described biased positions to catch the jutting end portions 182 of the two opposing side walls within the outward facing recesses 178 of the tabs 176, and thereby secure the cover to the battery box. To release this snap fit and remove the cover, a user must manually force the tabs 176 inward again to allow the bottom of these recesses to clear the jutting portions 182 of the side walls and pull the cover from the open end of the battery box.

In the same manner as the fan assembly, the power source assembly is sealed to the inflatable body wall surface around the respective opening therein by use of the flange 164 defining the greatest diameter cross-section of the assembly normal to its longitudinal axis. The actuable portion of the switch projects from or is at least accessible at the face of the cover portion 166 of the battery box cover opposite the switch compartment depending into the battery box interior, and this face of the battery box cover faces outwardly away from the inflatable body when the power source assembly is installed. The fan and power source assemblies are each nearly completely disposed within the inflatable, and thus do not project notably therefrom and thereby have minimimal if any noticeable effect on the appearance of the inflatable display. The wires connecting the power source and fan are also disposed entirely within the inflatable body, and thus do not detract from its outward appearance. Wiring of the on/off switch, battery contacts and motor to enable user-control over actuation and deactivation of the fan are well within the skill of the person of ordinary skill in the art, and thus are not described herein in detail.

It will be appreciated that power supplies and air delivery units of different structural detail than those described herein above may be similarly be installed in a sealed manner with a body formed substantially of air-impermeable flexible material to define a self-inflating sealed air inflatable. Also, the fan and power source units need not necessarily be separated by a flexible conductive connection and positioned at different sides of the inflatable bottom as described herein. For example, the power source and fan could be integrated into a single assembly for installation at a common side of an inflatable, or even within a common single opening in the inflatable body wall. However, positioning separate units at the bottom of the display and at opposing sides thereof lends stability to the inflated display. While units disposed on opposite sides of, or at least spaced apart positions along, the display could be connected by a non-flexible connection containing the conductive electrical connections required to operate the air delivery unit, this would require production of units having different connection dimensions depending on the inflatable display body with which they are used. A relatively long flexible connection could be used with inflatable displays of a wide variety of sizes, as the flexible cord or wire grouping can simply be coiled up or otherwise contained within a smaller display not requiring the full length of the connection between the units. An alternate embodiment could use a built-in fan assembly arranged with a power cord featuring a conventional power plug configured to couple with a conventional mains power socket as an alternative to a battery based power supply. This would embodiment would still eliminate the need to transport inflating equipment separate from the display body, but would be limited to use in areas where mains power or a suitable generator are available.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A self-inflating inflatable display comprising:
a body having an air impermeable flexible skin defining an interior enclosure of the body that is exandable and compactable by respective introduction and removal of air from the interior enclosure through at least one opening in the body; and
an air delivery device fixed to the body and defining an openable and closable air flow passage communicating with the interior enclosure of the body and an external environment thereoutside through a respective opening in the body, the air delivery assembly comprising an air conveying mechanism selectively operable to convey air from the exterior environment into the interior enclosure through the air flow passage to effect inflating of the body.

2. The display according to claim 1 wherein the air conveying mechanism comprises a fan.

3. The display according to claim 1 further comprising a power source fixed to the body and conductively connected to the air conveying mechanism to effect selective powering thereof.

4. The display according to claim 3 wherein the power source is disposed substantially within the interior enclosure.

5. The display according to claim 4 wherein the power source comprises a control device operable from the external environment to activate the air conveying mechanism.

6. The display according to claim 3 wherein the air delivery device and the power source are disposed at opposite sides of the interior enclosure.

7. The display according to claim 3 wherein the power source comprises a battery carrier fixed to the body and arranged to carry at least one battery.

8. The display according to claim 3 wherein the power source and the air delivery device are conductively connected through a flexible connection disposed at least partially within the interior enclosure.

9. The display according to claim 1 comprising a closure member operable from the outside environment to move between open and closed positions to open and seal off the air flow passage respectively.

10. The display according to claim 9 wherein the closure member is threaded to mate with a threaded end of the air flow passage.

11. The display according to claim 9 wherein the closure member is tethered to the air delivery device.

12. The display according to claims 1 wherein the air delivery device is disposed substantially within the interior enclosure.
